(19) United States
(12) Patent Application Publication
(10) Pub. No.: US 2023/0306440 A1
(43) Pub. Date: Sep. 28, 2023

(54) SYSTEMS AND METHODS FOR REAL-TIME PROCESSING OF PRODUCT ORDERS

(71) Applicant: The Toronto-Dominion Bank, Toronto, CA (US)

(72) Inventors: Milos DUNJIC, Oakville (CA); David Samuel TAX, Toronto (CA); Jonathan Joseph PRENDERGAST, West Chester, PA (US); Christopher Mark JONES, Villanova, PA (US); Vipul Kishore LALKA, Oakville (CA)

(73) Assignee: The Toronto-Dominion Bank, Toronto (CA)

(21) Appl. No.: 17/702,196

(22) Filed: Mar. 23, 2022

(51) Int. Cl. G06Q 30/00; G06Q 30/06; G06Q 10/08

(52) U.S. Cl. CPC G06Q 30/018; G06Q 30/0635; G06Q 30/0609; G06Q 10/087

(57) ABSTRACT

A computer-implemented method is disclosed. The method includes: receiving, via a computing device of a transferor entity, a first request to process a transfer of resources associated with a first resource account, the first request indicating a maximum resource transfer amount for the transfer; generating a locked virtual allocation of resources associated with the first resource account, the virtual allocation representing a defined quantity of resources committed for the transfer; obtaining request data for a second request to transfer resources to a second resource account, the request data indicating a minimum requested resource amount; validating the second request based on identifying information of a recipient entity associated with the second request; determining that the first request and the second request satisfy a defined resource transfer condition; and in response to the determining, automatically granting, to the recipient entity, access to the virtual allocation of resources.

### TECHNICAL FIELD

The present disclosure relates to order management systems and, in particular, to systems and methods for real-time processing of product orders.

### BACKGROUND

E-commerce offers merchants and customers myriad options for transacting in goods or services. Conventional e-commerce platforms connect customers to merchants' online storefronts and enable customers to place orders for products, with an expectation of successful fulfillment of those orders. In particular, customers order products by arranging for payment of the fixed retail prices of those products. The traditional “fixed-price” model limits the types of interactions between customers and merchants at point-of-sale (POS).

### BRIEF DESCRIPTION OF DRAWINGS

Reference will now be made, by way of example, to the accompanying drawings which show example embodiments of the present application and in which:

FIG. 1 is a schematic operation diagram illustrating an operating environment of an example embodiment;

FIG. 2A is a high-level schematic diagram of an example computing device;

FIG. 2B shows a simplified organization of software components stored in memory of the example computing device of FIG. 2A;

FIG. 3 shows, in flowchart form, an example method for processing resource transfer requests in connection with a resource account;

FIG. 4 shows, in flowchart form, an example method for processing product purchase orders;

FIG. 5 shows, in flowchart form, an example method for scheduling fulfillment of product purchase orders;

FIG. 6 shows, in flowchart form, an example method for automating sale of inventory of a merchant's products; and

FIG. 7 shows, in flowchart form, an example method for processing sell orders from multiple merchants.

Like reference numerals are used in the drawings to denote like elements and features.

### DETAILED DESCRIPTION OF EXAMPLE EMBODIMENTS

In an aspect, the present disclosure describes a computing system. The computing system includes a processor, a communications module coupled to the processor, and a memory coupled to the processor. The memory stores instructions that, when executed, configure the processor to: receive, via a computing device of a transferor entity, a first request to process a transfer of resources associated with a first resource account, the first request indicating a maximum resource transfer amount for the transfer; generate a locked virtual allocation of resources associated with the first resource account, the virtual allocation representing a defined quantity of resources committed for the transfer; obtain request data for a second request to transfer resources to a second resource account, the request data indicating a minimum requested resource amount; validate the second request based on identifying information of a recipient entity associated with the second request; determine that the first request and the second request satisfy a defined resource transfer condition; and in response to the determining, automatically grant, to the recipient entity, access to the virtual allocation of resources.

In some implementations, determining that the first request and the second request satisfy a defined resource transfer condition may include determining that the maximum resource transfer amount is greater than or equal to the minimum requested resource amount.

In some implementations, generating the locked virtual allocation of resources may include processing pre-authorization data for authorizing transfer of the defined quantity of resources from the first resource account.

In some implementations, the instructions, when executed, may further configure the processor to prevent access to the pre-authorization data by the transferor entity after generating the locked virtual allocation of resources.

In some implementations, the first request may comprise a product purchase order for purchasing a product at a first price and the second request comprises a product sell order for selling the product at a second price.

In some implementations, the instructions, when executed, may further configure the processor to: store, in the memory, a data object including a first list of one or more product purchase orders and a second list of one or more product sell orders; and identify matches between product purchase and sell orders of the data object based on defined order fulfilment criteria.

In some implementations, identifying matches between product purchase and sell orders may include: identifying one or more product purchase orders of the data object that are associated with a highest purchase price; and identifying one or more product sell orders of the data object associated with a lowest sale price that is greater than or equal to the highest purchase price.

In some implementations, granting access to the virtual allocation of resources may include automatically initiating a transfer of the defined quantity of resources to the second resource account.

In some implementations, validating the second request may include verifying that the recipient entity is an authenticated merchant associated with the product based on the identifying information.

In some implementations, the resources may be transferred via a real-time payment rail using an ISO20022 message including identifying information of the transferor entity.

In another aspect, the present disclosure describes a computer-implemented method. The method includes: receiving, via a computing device of a transferor entity, a first request to process a transfer of resources associated with a first resource account, the first request indicating a maximum resource transfer amount for the transfer; generating a locked virtual allocation of resources associated with the first resource account, the virtual allocation representing a defined quantity of resources committed for the transfer; obtaining request data for a second request to transfer resources to a second resource account, the request data indicating a minimum requested resource amount; validating the second request based on identifying information of a recipient entity associated with the second request; determining that the first request and the second request satisfy a defined resource transfer condition; and in response to the determining, automatically granting, to the recipient entity, access to the virtual allocation of resources.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Merchants can offer their products to customers through various different e-commerce channels, such as websites, dedicated retail applications, social media platforms, and the like. For example, a customer may visit a merchant's online storefront, browse a catalogue of products to select a specific product item, and submit an order for the selected product using the merchant's checkout interface. During the checkout process, the customer specifies a payment method and consents to a payment towards purchase of a selected product, for example, by confirming submission of the product order. In particular, the customer indicates their agreement to purchase the selected product at a fixed retail price. The retail price of the product is fixed by the merchant, and any customer wishing to purchase the product is required to pay the retail price when placing an order for the product.

This traditional model of fixed-price sales is limiting for both customers and merchants. Customers that deem a current retail price of a particular product to be higher than their own valuation/maximum bid price may be permanently dissuaded from purchasing the product, or would need to continuously monitor the retail price for changes. As one consequence, customers may expend resources to monitor product information until such time that the retail price aligns with their valuation of the product. For merchants, in order to increase sales of a product, the retail price of the product may need to be reduced. Committing to a lower retail price may make it difficult for the merchant to compete with other merchants that sell the product, isolate the effect of the price change on revenue, or to later raise the retail price of the product.

Computing systems may also engage in interactions that involve transfers of resources. In certain contexts, it may be desired for a client computing device to execute a computer program that has an associated computing resource (e.g., CPU, memory, and the like) cost. For example, a client computing device may request access to certain application software to execute using computing resources that are available on the device. In certain other contexts, it may be desired for a server computing system to “borrow” computing resources from one or more client systems in order to execute a computer program. For example, the server computing system may host a computer program having a certain resource cost and request that client systems transfer a fixed quantity of computing resources to the server such that the resources may be deployed for executing the computer program. If the resource cost for the computer program is fixed at a relatively high level, a client computing device may not have the capacity to lend computing resources to a server or to execute the computer program. In particular, due to the limited amount of computing resources that are available on the client computing device at any given time, the client computing device may not have sufficient resources for transferring or allocating toward execution of the computer program at the high fixed resource cost. For a provider (e.g., vendor, administrator, etc.) of the computer program, this may represent a loss of sales or inadequate distribution of the computer program to intended end users/systems. A server computing system that is unable to borrow computing resources from client systems may suffer from a deficiency in resources for executing the computer program.

The present application describes technological solutions for overcoming some of the above-mentioned limitations of existing systems. The disclosed technology of the present application represents improvements in order management systems and, more particularly, improved techniques for processing product orders based on variable attribute modeling and real-time payment processing integration. The disclosed solutions provide improvements over order management systems that operate based on traditional fixed-price models of customer-merchant interactions and that de-couple order fulfillment from payment processing. Further, the disclosed solutions facilitate efficient resource allocation for computing systems adapted for executing computer programs (or computing tasks, etc.), based on variable computing resource cost modeling. By implementing the solutions, a greater number of computing systems may be able to access and execute certain computer programs, resulting in improved distribution of such programs in a networked environment.

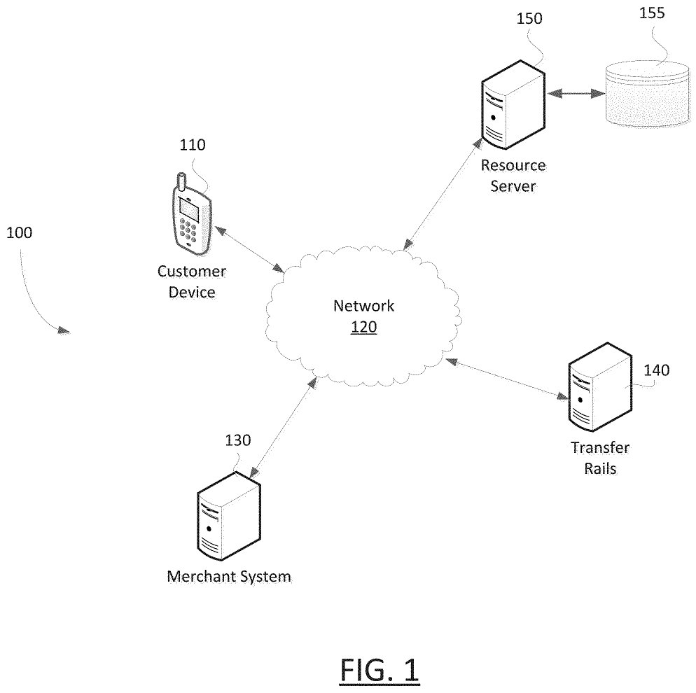

Reference is first made to FIG. 1, which is a schematic diagram of an exemplary operating environment in accordance with embodiments of the present disclosure. Specifically, FIG. 1 illustrates components of a system 100 for processing transfers of resources associated with resource accounts. In at least some embodiments, the system 100 may be configured to implement an order processing system. The system 100 may, for example, comprise a computer system including components that cooperate to manage payment processing and order fulfillment processes in connection with product orders on e-commerce channels.

As illustrated, a resource server 150 (which may also be referred to as a server computer), the customer device 110, and the merchant system 130 communicate via the network 120. The customer device 110 is a computing device that is associated with a customer entity. In at least some embodiment, the customer may have resources associated with the resource server 150. The customer may use the customer device 110 to browse products on various e-commerce channels and place orders for purchasing one or more selected products. The customer device 110 may take a variety of forms including, for example, a mobile communication device such as a smartphone, a tablet computer, a wearable computer such as a head-mounted display or smartwatch, a laptop or desktop computer, or a computing device of another type.

The merchant system 130 is a computing system that is associated with a specific merchant entity. In particular, the merchant system 130 is associated with a merchant that offers products on one or more e-commerce channels. A merchant may receive, via the merchant system 130, order data associated with product orders originating on e-commerce channels. For example, the merchant system 130 may process order data of product purchase orders that are placed using customer devices 110. The merchant system 130 may be configured to implement various merchant services relating to, for example, product sales, merchant storefront management, inventory control, and customer service support.

The resource server 150 may track, manage, and maintain resources, make lending decisions, and/or lend resources to the entity. The resources may, for example, be computing resources, such as memory, processor cycles, and the like. By way of further example, the resources may include stored value, such as fiat currency, which may be represented in a database. For example, the resource server 150 may be coupled to a database 155, which may be provided in secure storage. The secure storage may be provided internally within the resource server 150 or externally. The secure storage may, for example, be provided remotely from the resource server 150. For example, the secure storage may include one or more data centers. The data centers may, for example, store data with bank-grade security.

In at least some embodiments, the resource server 150 may be a financial institution server that is operated by a financial institution, and the customer and/or merchant entities associated with the customer devices 110 and merchant system 130, respectively, may be customers of the financial institution.

The database 155 may include data records for a plurality of accounts and at least some of the data records may define a quantity of resources associated with an entity. For example, an entity that is associated with the customer device 110 may be associated with a resource account having one or more data records in the database. The data records may reflect a quantity of stored resources that are associated with the entity. Such resources may include owned resources and, in at least some embodiments, borrowed resources (e.g., resources available on credit). The quantity of resources that are available to or associated with an entity may be reflected by a balance defined in an associated data record such as, for example, a bank balance.

The customer device 110, the merchant system 130, and the resource server 150 are computing systems and may be in geographically disparate locations. Put differently, the customer device 110 may be remote from one or both of the merchant system 130 and the resource server 150.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

As shown in FIG. 1, the system 100 may include a real-time transfer rail 140. In at least some embodiments, the real-time transfer rail 140 may be a payment rail. For example, the real-time transfer rail 140 may be hosted by a payment system that includes a real-time payment server. The payment system may be associated with a third-party and be configured to receive a resource (e.g., data) transfer request. The resource transfer request may include a request to transfer resources associated with a first data record to a second data record. The first data record may comprise a data record of a transferor and the second data record may comprise a data record of a recipient. For example, the first data record may be associated with a first financial institution database and the second data record may be associated with a second financial institution database.

The request to transfer resources may be a request to transfer data such as, for example, units of value. The units of value may include a quantity of currency. The transferor may initiate the resource transfer request using, for example, a computing device. The resource transfer request may be formatted as an ISO2022 message and may include one or more parameters. The ISO2022 format is a data-rich messaging format that provides the real-time transfer rail 140 with a clear and nuanced format of data. The one or more parameters may be included as metadata in the resource transfer request. The parameters may include, for example, resource definition data. The resource definition data defines what is requested to be transferred. By way of example, the resource definition data may define a resource that is stored in or otherwise associated with a data record associated with the transferor. The resource may represent units of value, such as a quantity of a currency.

Responsive to receiving a resource transfer request, the real-time payment system may complete the requested resource transfer using the real-time transfer rail 140. Specifically, the real-time payment server may be configured to receive the resource transfer request and to facilitate the resource transfer from the first data record associated with the transferor to the second data record associated with the recipient in real-time. In some embodiments, the resource transfer may be irrevocable; that is, the transferor may not be able to retrieve the transferred resources after completion of the transfer.

The real-time transfer rail 140 is configured to complete resource transfer requests in real-time or substantially in real-time. In at least some embodiments, real-time is defined as being within seconds. Certain factors, such as network traffic, may limit the immediacy of real-time transfers and/or processing of transfer requests.

In the example of FIG. 1, the resource server 150 may provide both data transfer processing (e.g., bill payment) and data holding (e.g., banking) functions. That is, the resource server 150 may be both a financial institution server and a bill payment processing server.

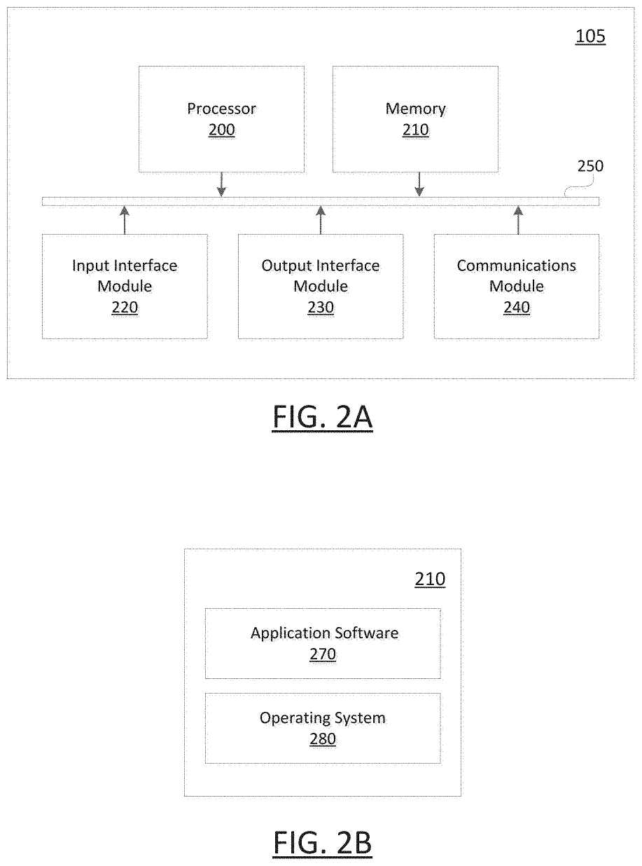

FIG. 2A is a high-level operation diagram of the example computing device 105. In some embodiments, the example computing device 105 may be exemplary of one or more of: the customer device 110, the merchant system 130, and the resource server 150. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. The processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned exemplary input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

The communications module 240 may allow the example computing device 105 to communicate using near-field communication (NFC), via Wi-Fi™, using Bluetooth™ or via some combination of one or more networks or protocols. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. In some embodiments, the application software 270 may include a retail application for accessing retail services of merchants. For example, the application software 270 may include a dedicated mobile app for accessing an online storefront of a particular merchant or a mobile app associated with an online marketplace (e.g., eBay) or e-commerce platform. Using the application software 270 (e.g., retail application), customers can perform product searches, browse merchant catalogues, and place orders for products, while merchants can manage their online storefronts and coordinate order fulfillment processes.

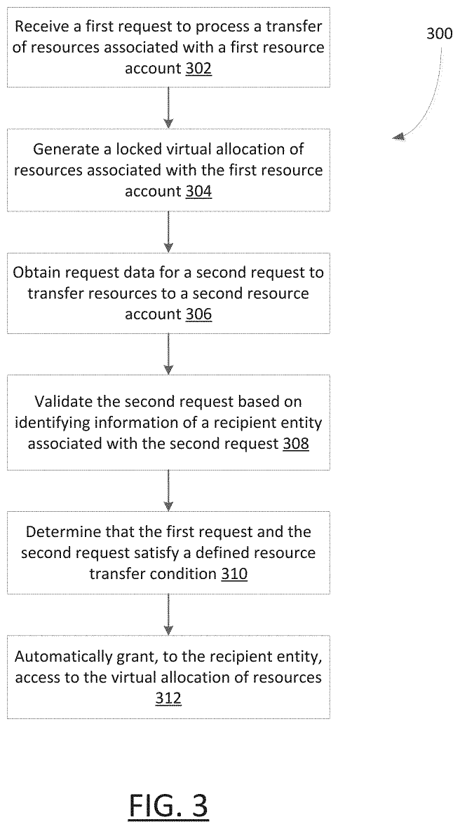

Reference is made to FIG. 3, which shows, in flowchart form, an example method 300 for processing resource transfer requests. Specifically, the method 300 allows for handling requests to transfer resources that are associated with a resource account. By way of example, the method 300 may be performed as part of a process for configuring real-time transfer of funds from a customer's bank account towards payment for one or more product purchase orders. As another example, the method 300 may be performed as part of a process for configuring transfers/allocations of computing resources associated with client computing devices in connection with execution of one or more computer programs (or computing tasks, etc.). Operations 302 and onward may be performed by processors of a computing device such as, for example, the processor 200 (FIG. 2) of one or more suitably configured instances of the example computing device 105 (FIG. 2). The method 300 may be implemented, for example, by a computing system, such as the resource server 150 of FIG. 1, that is communicably connected to a client device associated with a resource account.

A resource transfer may be requested on a client device for a number of reasons. In an e-commerce context, a payment transfer associated with a product purchase order may be requested to be configured by a customer. The payment transfer may, for example, be a real-time payment, or transfer of funds, from a designated bank account in connection with the purchase of a product. In particular, the payment transfer may be a funds transfer that is authorized to be initiated automatically upon successful processing of a product purchase order. In a computing context, a transfer/allocation of computing resources associated with a client computing device may be requested. The computing resources may be requested to be transferred/allocated from a pool of available resources for the client computing device in connection with, for example, execution of a computer program that may be executed on the client computing device.

In operation 302, a computing system receives, via a device of a transferor entity, a first request to process a transfer of resources associated with a first resource account. The first resource account is an account containing or that represents a holding of resources associated with the transferor. For example, the first resource account may be a user account at a resource server, such as a bank account. As another example, the first resource account may be a “pooled” account representing a resource pool associated with a client computing device. The resource pool may, for example, comprise system resources, which may be physical or virtual components of limited availability, associated with the client computing device.

The first request includes, at least, an indication of a maximum resource transfer amount for the transfer. For example, the first request may indicate a maximum payment amount for a requested transfer of funds. The maximum resource transfer amount may represent, for example, an upper limit on the quantity of resources that the transferor designates for the requested transfer. In some embodiments, the first request may also include an indicator (e.g., timestamp) of a time when the first request was made.

In some embodiments, the first request may comprise a product purchase order for purchasing a product at a first price. For example, the first request may be automatically generated (e.g., at a customer device) when a customer submits an order to purchase a product or a defined quantity of a product. The first price may be the maximum resource transfer amount for the product purchase order, representing a valuation of the product by the customer. In particular, the product purchase order may include, at least, an identifier of the customer, an identifier of the product (and/or quantity) that is desired to be purchased, and an indicator of a price that reflects how much the customer wishes to pay for the product(s).

In some other embodiments, the first request may comprise a request to execute a computer program using computing resources associated with a client computing device. The first request may indicate, for example, an amount of available computing resources of the client computing device that can be transferred/allocated towards executing the computer program. In particular, the first request may include, at least, an identifier of the client computing device, an identifier of a computer program (or computing task, etc.) that is desired to be executed, and an indicator of a quantity of computing resources that reflects how much of the available computing resources is desired to be committed for executing the computer program.

In operation 304, the computing system generates a locked virtual allocation of resources associated with the first resource account. The virtual allocation may be generated automatically in response to receipt of the first request at the computing system. Additionally, or alternatively, the virtual allocation may be generated upon confirmation, for example, provided by a transferor associated with the first request. A virtual allocation represents a defined quantity of resources that are committed for the transfer. In particular, a virtual allocation comprises a combination of a resource transfer associated with the first request and a quantity of resources that are committed to be transferred by the resource transfer from the first resource account. In this way, the first request by the transferor effectively binds a certain quantity of resources (e.g., the maximum transfer amount) for the requested transfer.

In at least some embodiments, a virtual allocation may be generated by storing allocation data in association with the first resource account. For example, the computing system may store, in memory, allocation data identifying the requested transfer, the defined quantity of resources to be transferred, and conditions for automatically initiating the requested transfer. The allocation data may be stored in association with one or more of the data records associated with the first resource account. Generally, allocation data that is stored in association with a resource account represents data which may be used by the computing system when processing transfers associated with the resource account. In particular, the allocation data may include transfer information for resource transfers that are configured to be automatically initiated responsive to certain pre-defined trigger conditions, without any additional input by a transferor associated with the resource account.

In some embodiments, the computing system may process pre-authorization data for authorizing transfer of the defined quantity of resources from the first resource account. The pre-authorization data is provided by a transferor entity associated with the first resource account. For example, a transferor (e.g., account owner) may provide, via an input interface, confirmation of parameters, such as transfer amount, resource account identifier, etc., of a pre-authorized resource transfer. The pre-authorization may be required for generating the virtual allocation of resources and/or locking a generated virtual allocation associated with the first resource account.

Additionally, or alternatively, the computing system may generate a first transfer data object as part of generating the virtual allocation associated with the first resource account. The first transfer data object corresponding to the first request may, for example, may be included in a queue of a plurality of transfer data objects representing transfers of resources from the first resource account. The first transfer data object may include data defining, at least, transfer amount, resource account identifier, conditions for initiating transfer, etc.

The virtual allocation of resources is “locked” to prevent modification of the resource commitment towards the requested transfer. In particular, the computing system may configure the virtual allocation such that access to the virtual allocation by the transferor is restricted. For example, the virtual allocation and its associated parameters may not be modified by the transferor for at least a defined period of time after the transferor makes the first request. In this way, the computing system may ensure that the transferor's commitment of resources for the requested transfer (represented by the virtual allocation) is a firm commitment, and not one that can be readily withdrawn or modified. The transferor may be prevented from, for example, modifying pre-authorization data associated with the requested transfer for a defined period of time after making the first request to process the transfer of resources.

The computing system obtains request data for a second request to transfer resources to a second resource account, in operation 306. Specifically, the second resource account is an account associated with a recipient of a transfer that is requested in the second request. The second resource account may be, for example, a user account at a resource server, or a pooled account representing a pool of system resources associated with a computing device. The request data of the second request indicates a minimum requested resource amount, or a minimum quantity of resources requested to be transferred/allocated to the second resource account. In an e-commerce context, the second request may comprise a sell order to sell a certain product at a second price. For example, the second request may be automatically generated (e.g., at a merchant system) when a merchant submits an order to sell a product or a defined quantity of a product. The second price may be the minimum requested resource amount, representing a valuation of the product by the merchant.

In operation 308, the computing system validates the second request based on identifying information of a recipient entity associated with the second request. Specifically, the computing system may determine whether the second request originates from an entity that is authorized to receive a transfer of resources associated with the first resource account. In the context of product order processing, the computing system may check whether a source of the second request is a merchant associated with the product. That is, the second request may be validated based on verifying that the recipient associated with the second request is an authorized merchant of the product. The computing system may first verify, based on the identifying information of the recipient, that the second request originates from a merchant of the product and that said merchant is authorized to accept purchase orders of the product, before further processing of the second request. In some embodiments, an authorized merchant of the product may additionally be required to be authenticated to the computing system. For example, a merchant may be required to provide authentication credentials as part of the process of making the second request to the computing system.

The computing system then determines whether the first request and the second request satisfy one or more defined resource transfer conditions, in operation 310. In some embodiments, a resource transfer condition may relate to transfer amounts associated with the first and second requests. Specifically, the first request and the second request may be determined to satisfy a resource transfer condition if the maximum resource transfer amount associated with the first request is greater than or equal to the minimum requested resource amount associated with the second request. For example, if a maximum price associated with a product purchase order is greater than or equal to a minimum price associated with a sell order for the product, the resource transfer conditions may be determined to be satisfied. In this way, a first request to process a transfer of resources from a first resource account may be “matched” with a second request to transfer resources to a second resource account if the computing system determines that the first and second requests cooperatively satisfy certain defined resource transfer conditions.

In response to determining that the first and second requests satisfy defined resource transfer conditions, the computing system automatically grants, to the recipient entity, access to the virtual allocation of resources, in operation 312. In particular, the recipient is granted authorization to access the resources that are committed by the virtual allocation. The locked virtual allocation is “unlocked”, and a transfer of the defined quantity of resources associated with the virtual allocation is automatically initiated. Specifically, the computing system causes the resources to be automatically transferred to the second resource account associated with the recipient. By way of example, in the e-commerce context, the computing system may cause or initiate a transfer of funds to a bank account of a merchant associated with a sell order for a product. The amount of funds transferred may be equal to the maximum price associated with a customer's product purchase order for the product. In a computing context, the computing system may cause or initiate a transfer/allocation of computing resources associated with a client computing device, in operation 312. The transfer/allocation of resources may, for example, be for enabling the client computing device to execute a computer program. Additionally, or alternatively, the computing system may grant, to a remote computing device, access to a defined quantity (e.g., maximum resource transfer amount) of resources associated with a client computing device, for enabling the remote computing device to execute a computer program using said resources.

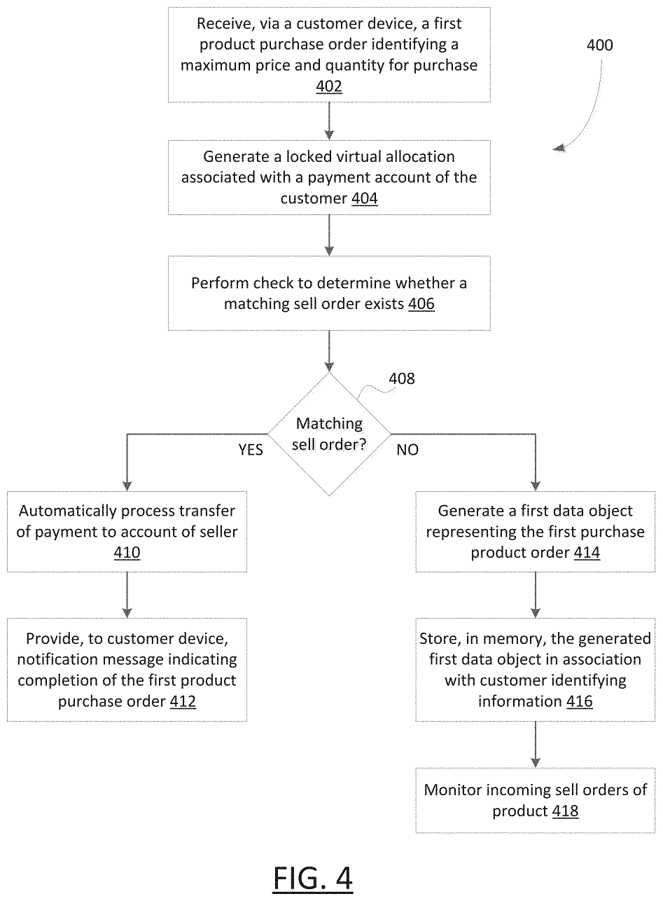

Reference is now made to FIG. 4, which shows, in flowchart form, an example method 400 for processing product purchase orders. In particular, the method 400 may be performed as part of a process for configuring real-time payments in connection with product purchase orders. Operations 402 and onward may be performed by processors of a computing device such as, for example, the processor 200 (FIG. 2) of one or more suitably configured instances of the example computing device 105 (FIG. 2). The method 400 may be performed, for example, by a computing system, such as the resource server 150 of FIG. 1, that is communicably connected to a client device associated with a resource account. The operations of method 400 may be performed in addition to, or as alternatives of, one or more of the operations of method 300.

A computing system may receive, via a customer device, a product purchase order, in operation 402. The product purchase order may be received via an e-commerce channel such as, for example, a merchant's storefront (e.g., website, mobile app, etc.), an online marketplace, and the like. The product purchase order may identify, at least, a product associated with the order, the customer placing the order, a maximum price associated with the order, and a quantity of the product for purchase at the maximum price. The maximum price may be a price that reflects a customer's valuation of the product, or a highest price that the customer is willing to pay to purchase the product. In at least some embodiments, the product purchase order may represent a customer's commitment to pay for the product. Specifically, the product purchase order may be associated with an express authorization for initiating and/or processing a payment towards purchase of the product. The authorized payment may, for example, be a funds transfer from an account of the customer in an amount equal to the maximum price identified in the product purchase order.

In response to receiving the product purchase order, the computing system generates a locked virtual allocation associated with a payment account of the customer, in operation 404. The payment account may, for example, be a bank account that is associated with the customer. In some embodiments, the computing system may store, in memory, allocation data in association with the customer's payment account. For example, the computing system may store allocation data identifying the pre-authorized payment and payment amount, and conditions for automatically initiating the payment. The allocation data may be stored in association with one or more data records associated with the customer's payment account. Generally, allocation data that is stored in association with a payment account represents data which may be used by the computing system when processing payments associated with the payment account. In particular, the allocation data may include payment information for pre-authorized payments that are configured to be automatically initiated responsive to certain pre-defined trigger conditions, without any additional input by a payer/customer associated with the payment account.

The computing system performs a check to determine whether a matching sell order for the received product purchase order exists, in operation 406. In at least some embodiments, the computing system stores order data of sell orders for sale of a defined quantity of the product. The sell orders may, for example, be provided via merchant systems of merchants that offer the product for sale. Each sell order of a product may identify, at least, a sale price representing a minimum price that the seller is willing to accept for the product (i.e., a minimum sale price). Merchants may submit sell orders to the computing system and request that the computing system match sell orders to product purchase orders. The computing system may, for example, maintain a list of one or more sell orders of a product, and automatically match incoming product purchase orders from customers with eligible sell orders. Additionally, or alternatively, the computing system may maintain a list of one or more product purchase orders of a product, and automatically match incoming sell orders from merchants with eligible product purchase orders.

When identifying matches between product purchase orders and sell orders, the computing system may be configured to perform comparisons of order data of product purchase orders with order data of sell orders. By way of example, the computing system may identify one or more sell orders (e.g., sell orders stored in memory) of a product that satisfy certain defined criteria in relation to an incoming product purchase order. The identified sell orders may, for example be those orders having an associated minimum sale price that is less than or equal to a maximum price associated with the product purchase order. Of the identified sell orders, a single sell order may be determined to be the match for the product purchase price. The “matching” sell order may, for example, be a sell order having the highest sale price that is less than or equal to the maximum price associated with the product purchase order.

If the computing system determines that a matching sell order exists (in operation 408), the computing system proceeds to automatically transfer a pre-authorized payment associated with the product purchase order. Specifically, the computing system automatically processes transfer of the pre-authorized payment to an account (e.g., a bank account) of the seller associated with the matching sell order, in operation 410. For example, the computing system may generate and transmit a payment message to a payment processer or network via a real-time payment rail. The payment message may, for example, be an ISO20022 message that includes identifying information (e.g., contact information, mailing address, etc.) of the payer/customer. The identifying information may be included in metadata associated with the payment message. The computing system may additionally notify the customer that the payment associated with the product purchase order has been initiated and/or processed. In particular, the computing system may provide, to a customer device, notification message indicating completion of the product purchase order, in operation 412. The notification message may be in the form of a push notification, email, SMS/MMS message, and the like.

On the other hand, if the computing system determines that there is no matching sell order for the product purchase order, the computing system stores order data of the product purchase order in memory. In some embodiments, the computing system generates a data object representing the product purchase order (operation 414) and stores the generated data object in memory. The data object can subsequently be processed and/or manipulated if or when more sell orders are received at the computing system for processing. The data object associated with the product purchase order may be stored in association with customer identifying information, in operation 416. The customer identifying information may include, for example, a name and identifier of an account (e.g., a bank account) associated with the customer. The computing system continues to monitor incoming sell orders of the product, in operation 418.

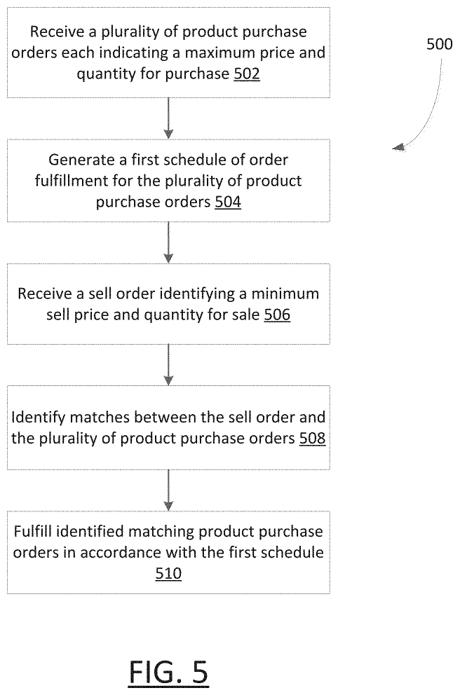

Reference is made to FIG. 5, which shows, in flowchart form, an example method 500 for scheduling fulfillment of product purchase orders. Operations 502 and onward may be performed by processors of a computing device such as, for example, the processor 200 (FIG. 2) of one or more suitably configured instances of the example computing device 105 (FIG. 2). The method 500 may be performed, for example, by a computing system, such as the resource server 150 of FIG. 1, that is communicably connected to customer devices of one or more customers and merchant systems associated with one or more merchants. The operations of method 500 may be performed in addition to, or as alternatives of, one or more of the operations of methods 300 and 400.

A computing system may be configured to receive product purchase orders from various customers and to process the received orders based on certain defined rules and policies. In operation 502, the computing system receives a plurality of product purchase orders. The product purchase orders may be received, for example, via e-commerce channels such as a merchant's storefront (e.g., website, mobile app, etc.), an online marketplace, and the like. In particular, the computing system may be communicably coupled to merchant systems, marketplace servers, etc. such that product purchase orders are processed by the computing system as part of order fulfilment processes for the orders. Each product purchase order indicates, at least, the product that is ordered by a customer, the customer that placed the order, a maximum purchase price specified by the customer for the purchase, and a quantity of products for purchase at the maximum price. In some embodiments, the product purchase order may additionally include a timestamp associated with the order, such as a time of purchase, projected time of payment, etc.

As the computing system receives product purchase orders, a schedule of order fulfillment for the orders is generated, in operation 504. That is, the computing system determines a schedule for fulfilling the product purchase orders that are received. The order fulfillment schedule indicates, at least, a priority order of processing the product purchase orders. In particular, the order fulfillment schedule may indicate an order in which product purchase orders from different customers are to be fulfilled based on matching with incoming and/or stored sell orders for the same products.

In at least some embodiments, the order fulfillment schedule generated by the computing system indicates a fulfillment order that is based on order time and maximum price. Specifically, the product purchase orders from different customers may be ordered by chronological order and by purchase price. For example, two or more different product purchase orders for a product that have the same purchase price may be ordered by a chronological order of product order placement, according to the order fulfillment schedule. As another example, product purchase orders that have a higher purchase price may be prioritized (i.e., precede in the fulfillment order) over other product purchase orders for the same product that have a lower purchase price. In this way, the plurality of product purchase orders may be ordered in a decreasing order of purchase price in the order fulfillment schedule, and for each purchase price level, the ordering of the product purchase orders may be based on a chronological order of purchase order placement.

In operation 506, the computing system receives a sell order from a merchant of a product. The sell order may be received, for example, via a merchant system associated with the merchant. The merchant may provide, to the computing system, input indicating parameters of a sell order to sell certain quantities of a product. The sell order indicates, at least, the product being sold by a merchant, the merchant selling the product, a minimum sale price specified by the merchant, and a quantity of the product for sale at the minimum sale price.

Upon receiving the sell order, the computing system identifies matches between the sell order and the plurality of product purchase orders, in operation 508. In particular, the computing system identifies a subset of the product purchase orders that satisfy defined order matching criteria. For example, the subset of product purchase orders having a purchase price that is greater than or equal to the minimum sale price associated with the sell order may be identified. That is, those product purchase orders which satisfy a price criterion in relation to the received sell order are identified by the computing system.

In operation 510, the computing system fulfills the identified matching product purchase orders in accordance with the order fulfillment schedule. The product purchase orders identified in operation 508 as satisfying defined order matching criteria are fulfilled in an order defined in the order fulfillment schedule. Since each product purchase order is for a defined quantity of a product, the product purchase orders are caused to be fulfilled by matching with corresponding quantity of the product from the sell order. The computing system continues the matching process to fulfill product purchase orders for the product until such a time when (1) there are no more unfulfilled product purchase orders, or (2) the quantity of the product for sale specified in the sell order are all matched with product purchase orders.

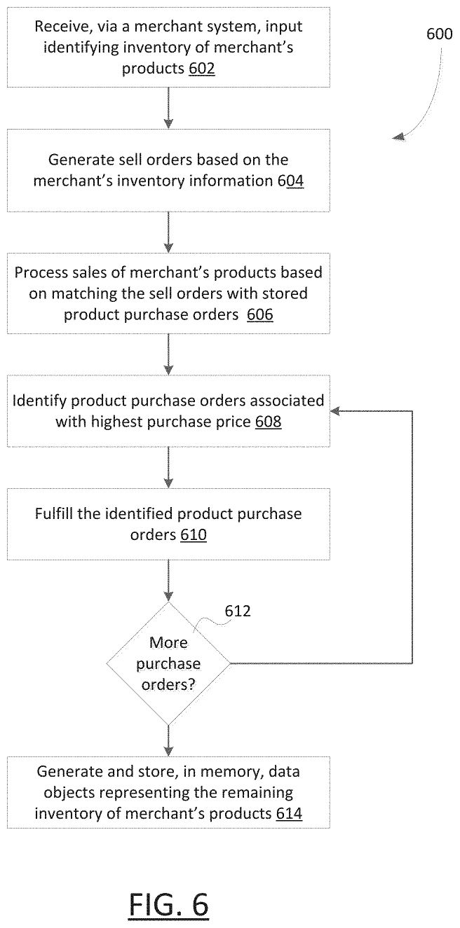

Reference is made to FIG. 6, which shows, in flowchart form, another example method 600 for automating sale of inventory of a merchant's products. Operations 602 and onward may be performed by processors of a computing device such as, for example, the processor 200 (FIG. 2) of one or more suitably configured instances of the example computing device 105 (FIG. 2). The method 600 may be performed, for example, by a computing system, such as the resource server 150 of FIG. 1, that is communicably connected to customer devices of one or more customers and merchant systems associated with one or more merchants. The operations of method 600 may be performed in addition to, or as alternatives of, one or more of the operations of methods 300 to 500.

A merchant may wish to reduce their inventory of particular products. In some instances, the merchant may request a third-party computing system to manage automated sale of all or part of their inventory. A computing system receives, via a merchant system, input identifying inventory of the merchant's products, in operation 602. The merchant input may indicate, for example, a list of products that are desired to be sold, minimum sale prices for those products specified by the merchant, and quantities of the products desired to be sold at the minimum sale prices.

Upon receiving the merchant's input, the computing system automatically generates sell orders based on the merchant's inventory information, in operation 604. The sell orders correspond to the product inventory that the seller desires to be sold. In at least some embodiments, the sell orders may comprise data objects that are automatically generated by the computing system and that contain order data corresponding to inventory for sale. Each sell order may, for example, be a data object (e.g., database record, file, etc.) containing information identifying, at least, a product for sale, a merchant selling the product, a minimum sale price per unit, and a quantity of the product to be sold at the minimum sale price. The data objects corresponding to sell orders may be stored in memory and categorized based on, for example, product, geographical region, etc. In particular, data objects corresponding to sell orders that share one or more common features (e.g., same good/service, delivery or fulfillment in a common geographical region, and the like) may be stored in association with each other in memory of the computing system.

In operation 606, the computing system processes sales of the merchant's products based on matching the generated sell orders with stored and/or incoming product purchase orders. The matching of sell orders with product purchase orders may be performed in a similar manner as any one or more of the matching mechanisms described above. For example, in some embodiments, the computing system may identify those product purchase orders that are associated with highest purchase prices (operation 608) and fulfill the identified product purchase orders (operation 610). Specifically, the computing system may fulfill product purchase orders, either stored or incoming, according to a decreasing order of purchase price associated with those product purchase orders. The fulfillment process proceeds by continuously checking for existence of more purchase orders (operation 612). Once all of the product purchase orders handled by the computing system are fulfilled, information regarding any unsold inventory of the merchant's products is stored in memory associated with the computing system. In particular, the computing system may generate and store, in memory, data objects representing the remaining inventory of the merchant's products, in operation 614.

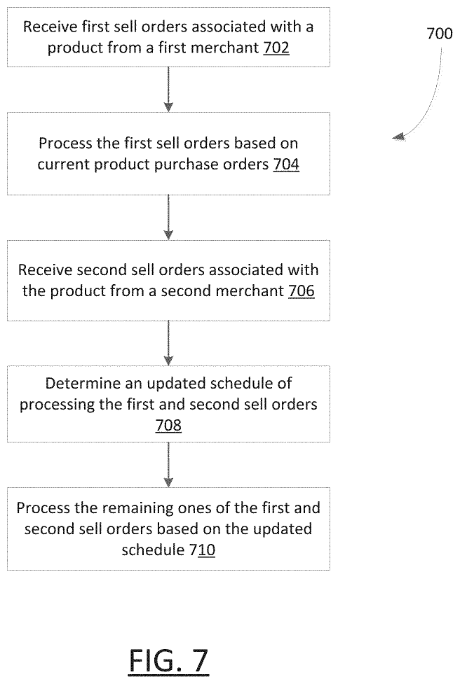

Reference is made to FIG. 7, which shows, in flowchart form, an example method 700 for processing sell orders from multiple merchant systems. Operations 702 and onward may be performed by processors of a computing device such as, for example, the processor 200 (FIG. 2) of one or more suitably configured instances of the example computing device 105 (FIG. 2). The method 700 may be performed, for example, by a computing system, such as the resource server 150 of FIG. 1, that is communicably connected to customer devices of one or more customers and merchant systems associated with one or more merchants. The operations of method 700 may be performed in addition to, or as alternatives of, one or more of the operations of methods 300 to 600.

As described with reference to FIG. 6, merchants may request a third-party computing system to handle sell orders for automated sale of their product inventory. When multiple different merchants use the same third-party computing system, an order of processing the merchants' sell orders may be required to be determined dynamically. In particular, as the third-party computing system processes incoming sell orders for multiple different merchants, an order of matching the sell orders to stored and/or incoming product purchase orders may be updated in real-time based on certain defined rules or policies.

In operation 702, a computing system receives first sell orders associated with a product from a first merchant. Each sell order indicates, at least, a product for sale, a merchant selling the product, a minimum sale price, and a quantity of the product for sale at the minimum sale price. The computing system processes the first sell orders based on currently stored and/or incoming product purchase orders (operation 704). That is, the computing system matches the first sell orders with those product purchase orders being handled by the computing system. The matching may be performed in a similar manner as any one or more of the matching mechanisms described above.

If the computing system receives second sell orders associated with the same product from a second different merchant (operation 706), an updated schedule for processing the first and second sell orders is determined, in operation 708. Specifically, a fulfillment order for matching the first and second sell orders with product purchase orders may be determined. In at least some embodiments, the fulfillment order may be determined based on at least one of minimum sale prices associated with the sell orders or sell order times (e.g., timestamps associated with sell orders). For example, the first and second sell orders may be ordered according to an increasing order of sale price and/or chronological order of sell order placement. The remaining ones of the first and second sell orders are then processed based on the updated schedule, in operation 710. In particular, the matching of sell orders with product purchase orders is performed based on the updated schedule/fulfillment order.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a communications module coupled to the processor; and
a memory coupled to the processor, the memory storing instructions that, when executed, configure the processor to:
receive, via a computing device of a transferor entity, a first request to process a transfer of resources associated with a first resource account, the first request indicating a maximum resource transfer amount for the transfer;
generate a locked virtual allocation of resources associated with the first resource account, the virtual allocation representing a defined quantity of resources committed for the transfer;
obtain request data for a second request to transfer resources to a second resource account, the request data indicating a minimum requested resource amount;
validate the second request based on identifying information of a recipient entity associated with the second request;
determine that the first request and the second request satisfy a defined resource transfer condition; and
in response to the determining, automatically grant, to the recipient entity, access to the virtual allocation of resources.

2. The computing system of claim 1, wherein determining that the first request and the second request satisfy a defined resource transfer condition comprises determining that the maximum resource transfer amount is greater than or equal to the minimum requested resource amount.

3. The computing system of claim 1, wherein generating the locked virtual allocation of resources comprises processing pre-authorization data for authorizing transfer of the defined quantity of resources from the first resource account.

4. The computing system of claim 3, wherein the instructions, when executed, further configure the processor to prevent access to the pre-authorization data by the transferor entity after generating the locked virtual allocation of resources.

5. The computing system of claim 1, wherein the first request comprises a product purchase order for purchasing a product at a first price and the second request comprises a product sell order for selling the product at a second price.

6. The computing system of claim 5, wherein the instructions, when executed, further configure the processor to:
store, in the memory, a data object including a first list of one or more product purchase orders and a second list of one or more product sell orders; and
identify matches between product purchase and sell orders of the data object based on defined order fulfilment criteria.

7. The computing system of claim 6, wherein identifying matches between product purchase and sell orders comprises:
identifying one or more product purchase orders of the data object that are associated with a highest purchase price; and
identifying one or more product sell orders of the data object associated with a lowest sale price that is greater than or equal to the highest purchase price.

8. The computing system of claim 1, wherein granting access to the virtual allocation of resources comprises automatically initiating a transfer of the defined quantity of resources to the second resource account.

9. The computing system of claim 5, wherein validating the second request comprises verifying that the recipient entity is an authenticated merchant associated with a product based on the identifying information.

10. The computing system of claim 1, wherein the resources are transferred via a real-time payment rail using an ISO20022 message including identifying information of the transferor entity.

11. A computer-implemented method, comprising:
receiving, via a computing device of a transferor entity, a first request to process a transfer of resources associated with a first resource account, the first request indicating a maximum resource transfer amount for the transfer;
generating a locked virtual allocation of resources associated with the first resource account, the virtual allocation representing a defined quantity of resources committed for the transfer;
obtaining request data for a second request to transfer resources to a second resource account, the request data indicating a minimum requested resource amount;
validating the second request based on identifying information of a recipient entity associated with the second request;
determining that the first request and the second request satisfy a defined resource transfer condition; and
in response to the determining, automatically granting, to the recipient entity, access to the virtual allocation of resources.

12. The method of claim 11, wherein determining that the first request and the second request satisfy a defined resource transfer condition comprises determining that the maximum resource transfer amount is greater than or equal to the minimum requested resource amount.

13. The method of claim 11, wherein generating the locked virtual allocation of resources comprises processing pre-authorization data for authorizing transfer of the defined quantity of resources from the first resource account.

14. The method of claim 13, further comprising preventing access to the pre-authorization data by the transferor entity after generating the locked virtual allocation of resources.

15. The method of claim 11, wherein the first request comprises a product purchase order for purchasing a product at a first price and the second request comprises a product sell order for selling the product at a second price.

16. The method of claim 11, further comprising:
storing, in memory, a data object including a first list of one or more product purchase orders and a second list of one or more product sell orders; and
identifying matches between product purchase and sell orders of the data object based on defined order fulfilment criteria.

17. The method of claim 16, wherein identifying matches between product purchase and sell orders comprises:
identifying one or more product purchase orders of the data object that are associated with a highest purchase price; and
identifying one or more product sell orders of the data object associated with a lowest sale price that is greater than or equal to the highest purchase price.

18. The method of claim 11, wherein granting access to the virtual allocation of resources comprises automatically initiating a transfer of the defined quantity of resources to the second resource account.

19. The method of claim 15, wherein validating the second request comprises verifying that the recipient entity is an authenticated merchant associated with the product based on the identifying information.

20. The method of claim 11, wherein the resources are transferred via a real-time payment rail using an ISO20022 message including identifying information of the transferor entity.
